(19) United States
(12) Patent Application Publication
(10) Pub. No.: US 2012/0157899 A1
(43) Pub. Date: Jun. 21, 2012

(54) MASSAGER

(75) Inventors: Koji Terada, Shiga (JP); Akihiro Takaya, Shiga (JP); Tomohiko Watanabe, Shiga (JP); Taichi Hamatsuka, Shiga (JP); Yoshimi Takahashi, Shiga (JP)

(73) Assignee: PANASONIC CORPORATION, Osaka (JP)

(21) Appl. No.: 13/393,423

(22) PCT Filed: Sep. 24, 2010
(86) PCT No.: PCT/JP2010/005759

§ 371 Date: Feb. 29, 2012

(30) Foreign Application Priority Data
Sep. 25, 2009 (JP) 2009-221616

(51) Int. Cl. A61H 9/00

(52) U.S. Cl. 601/149

(57) ABSTRACT

A massager in which a backrest and side walls holding massage members have a unified form, is provided. The massager has: a backrest including, in an integrated fashion, a backrest section in which a massage mechanism for massaging a user's back is provided, and a pair of projecting sections which project to the left and right-hand sides from at least the upper part of the backrest section; side walls which respectively project forwards from front surfaces of the pair of projecting sections; and air bags which are provided respectively on inner side faces of the pair of side walls and used for massaging the sides of the user leaning against the backrest section.

### TECHNICAL FIELD

The present invention relates to a massager, and in particular to a chair-type massager.

### BACKGROUND ART

For example, a massager disclosed in Patent Document 1 is known. The massager disclosed in Patent Document 1 comprises a backrest in which a massage mechanism for massaging a user's back is provided, side wall sections which are provided on the left and right-hand sides of the backrest and which project forwards from the backrest, and air bags which are embedded in inner side faces of the side walls sections.

In the massager described in Patent Document 1, it is possible to massage the sides of a user leaning against the backrest, and in particular, the user's shoulder regions, by repeating expansion and contraction of the air bags. Moreover, in the massager disclosed in Patent Document 1, by expanding the air bags, it is possible to prevent the user from being lifted up from the backrest during massaging by the massage mechanism.

However, the side wall sections of the massager described in Patent Document 1 are respectively attached on both side faces of the backrest, and project to either side from the backrest, and therefore the massager in Patent Document 1 has a unreasonable form when viewed as a chair.

Patent Document 1: Japanese Patent Application Laid-open No. 2005-192603

### SUMMARY OF THE INVENTION

It is an object of the present invention to provide a massager in which a backrest and side walls holding massage members have a unified form.

The present invention provides a massager, comprising: a backrest including, in an integrated fashion, a backrest section in which a massage mechanism for massaging a user's back is provided, and a pair of projecting sections which project to left and right-hand sides from at least an upper part of the backrest section; a pair of side walls which respectively project forwards from front surfaces of the pair of projecting sections; and a pair of massage members which are provided respectively on inner side faces of the pair of side walls and which can be switched between an expanded state and a contracted state in order to massage the sides of the user leaning against the backrest section.

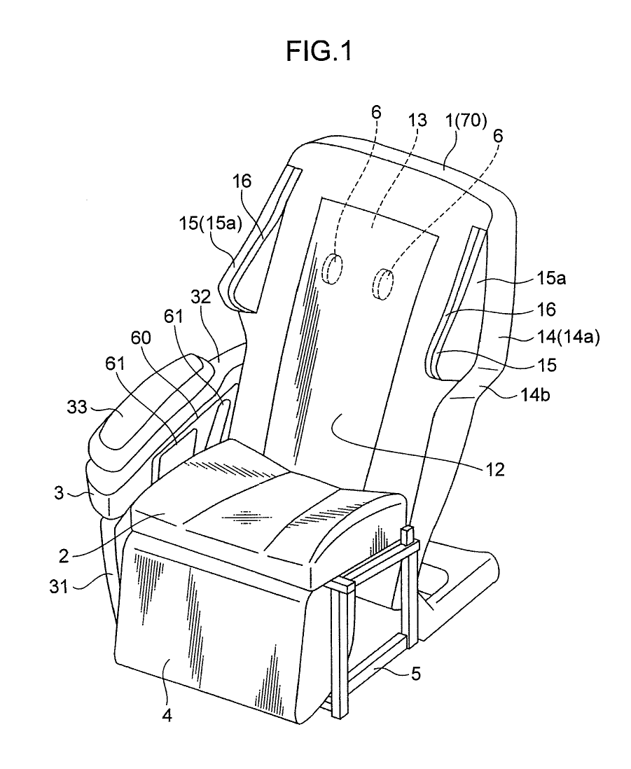

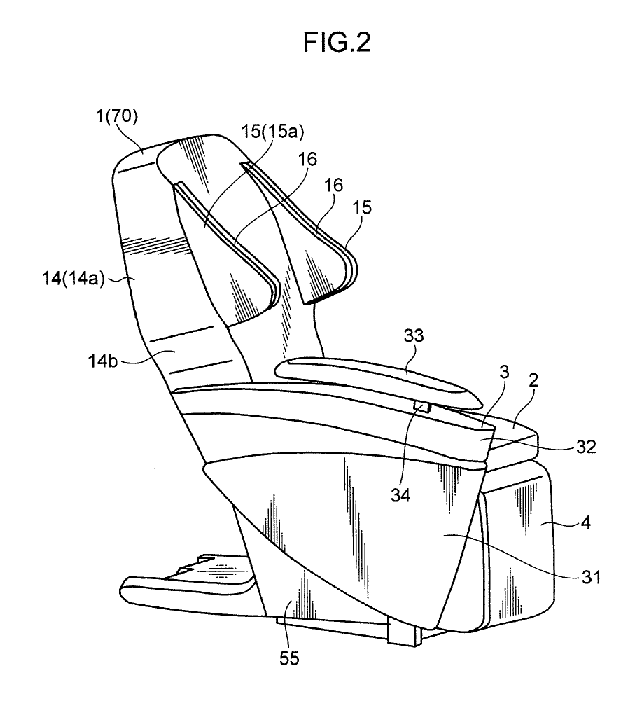

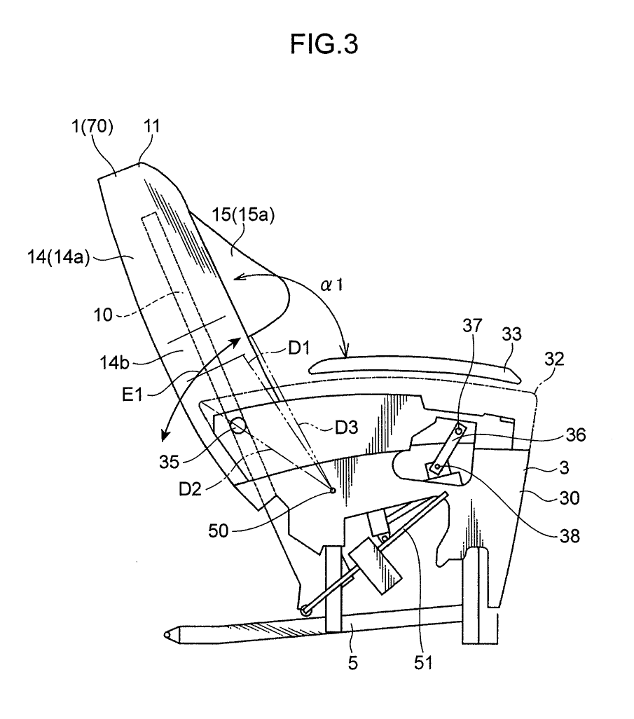

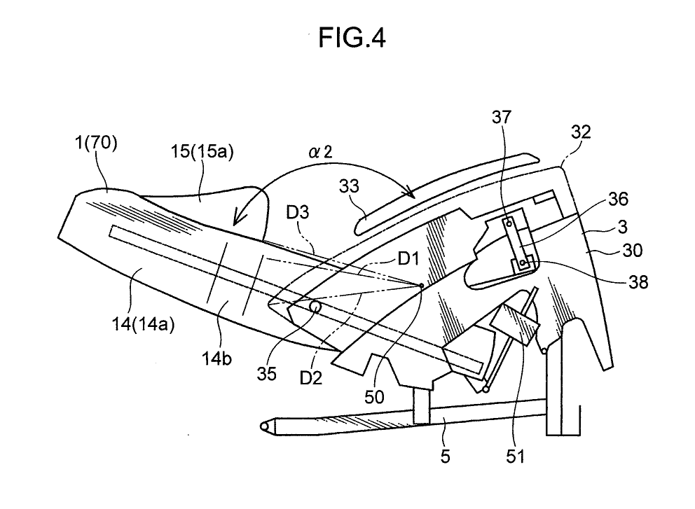

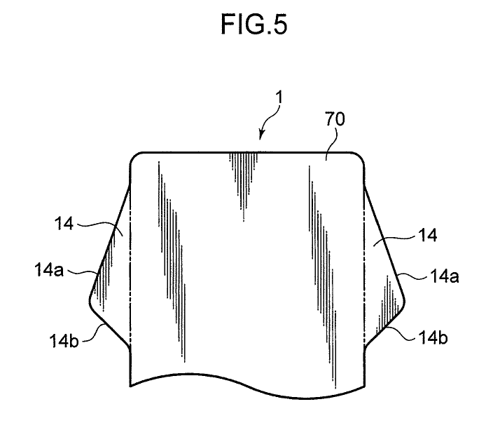

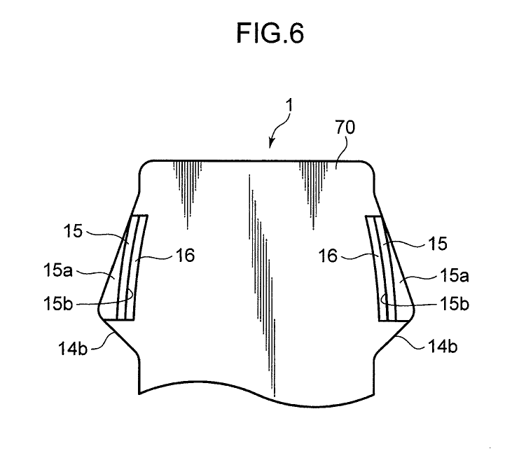

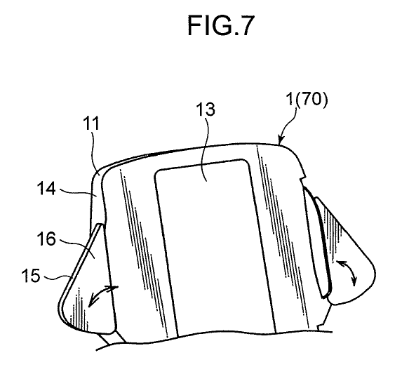

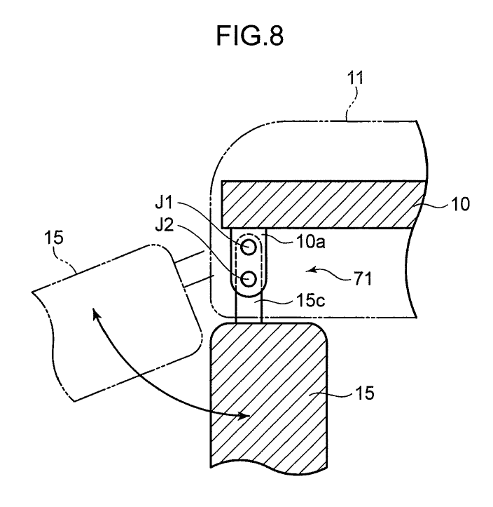

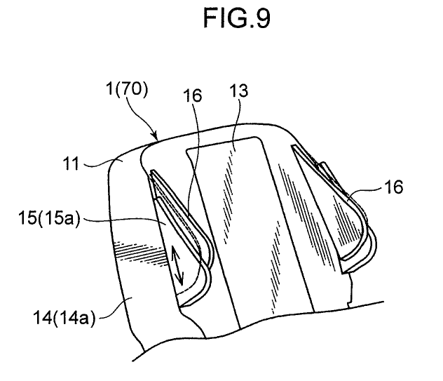

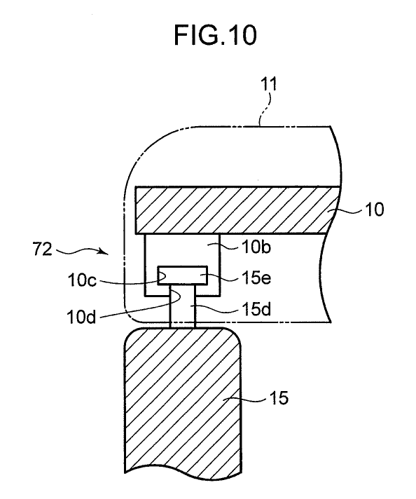

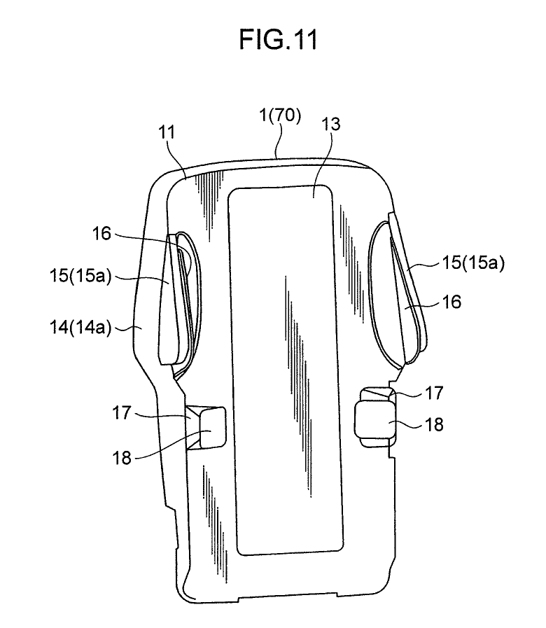

### BRIEF DESCRIPTION OF THE DRAWINGS

[FIG. 1] FIG. 1 is a perspective view showing a massager relating to one embodiment of the present invention.

[FIG. 2] FIG. 2 is a perspective diagram of the massager in FIG. 1 viewed from the upper left side.

[FIG. 3] FIG. 3 is a side view of the massager in FIG. 1.

[FIG. 4] FIG. 4 is a side view of the massager in FIG. 3 when reclined.

[FIG. 5] FIG. 5 is a front view diagram in which a portion of the backrest in FIG. 1 is omitted.

[FIG. 6] FIG. 6 is a front view diagram showing the side walls and the air bags added to the backrest in FIG. 5.

[FIG. 7] FIG. 7 is a perspective diagram showing a portion of a backrest relating to a further embodiment of the present invention.

[FIG. 8] FIG. 8 is a plan diagram showing a rotational mechanism provided in the backrest in FIG. 7.

[FIG. 9] FIG. 9 is a perspective diagram showing a portion of a backrest relating to yet a further embodiment of the present invention.

[FIG. 10] FIG. 10 is a plan diagram showing a sliding mechanism provided in the backrest in FIG. 9.

[FIG. 11] FIG. 11 is a perspective diagram showing a portion of a backrest relating to yet a further embodiment of the present invention.

### DESCRIPTION OF EMBODIMENTS

Below, a massager relating to one embodiment of the present invention is described in detail with reference to FIG. 1 to FIG. 6. The embodiment described below is one example of a concrete embodiment of the present invention, and is not intended to limit the technical scope of the present invention.

The chair-type massage shown in FIGS. 1 to 6 comprises: a backrest 1 in which a massage mechanism (not illustrated) for massaging a user's back is provided; a pair of side walls 15 which project forwards from the backrest 1; air bags (massage members) 16 which are provided respectively on inner side faces 15b of the side walls 15; a frame 5 which supports the backrest 1 in such a manner that the backrest 1 can be reclined backwards; a seat 2 which is provided on the frame 5 at a position below and in front of the backrest 1; a pair of armrests 3 which are provided on the left and right sides of the seat 2 (the left-side arm rest 3 is not shown in the drawing); and a footrest 4 which is provided below and in front of the seat 2. The footrest 4 is supported axially on the upper part of the front edge of the frame 5, so as to be rotatable about a horizontal axis. More specifically, the footrest 4 can be rotated between the position shown in FIG. 3 and FIG. 4 where the surface for resting the user's feet is facing forwards, and a position where the surface for resting the user's feet is situated in a substantially horizontal state in front of the seat 2.

Moreover, the massager also comprises a unit (not illustrated) for driving rotation of the footrest 4, a lift unit 51 for performing a reclining operation of the backrest 1, an air pump and valve (not illustrated) for supplying air to air bags, which are described below, and a frame cover 55 which covers the outer side of the frame 5. The unit for driving rotation of the footrest 4 and the lift unit 51, the air pump and the valve are respective disposed inside the frame 5.

As shown in FIG. 3, the lower part of the backrest 1 is supported by an axle (central axis) 50 which extends in the left/right direction with respect to the upper rear end of the frame 5, so as to be rotatable in the forward/backward direction about the central axis 50. In other words, the backrest 1 can be reclined in a reclining range E1 (see FIG. 3) between an upright attitude shown in FIG. 3 and a reclined attitude shown in FIG. 4. Furthermore, the lift unit 51 is provided between the lower end of the backrest 1 and the upper front end of the frame 5, and the backrest 1 is rotated with respect to the frame 5 about the central axis 50 by extension and contraction of this lift unit 51.

More specifically, the backrest 1 comprises a backrest frame 10 formed in a frame shape, a box-shaped frame 11 which covers the backrest frame 10, an outer cover 12 which covers the box-shaped frame 11, and a massage mechanism having a treatment element 6 which is provided inside the outer cover 12. The treatment element 6 is provided inside an opening 13 which is provided on the front surface of the box-shaped frame 11, so as to be movable vertically along the backrest frame 10. Massaging of the back of the user is performed by bringing the treatment element 6 into contact with the user's back via the outer cover 12.

Furthermore, as shown in FIG. 5, the backrest 1 comprises, in integrated fashion: a backrest section 70 in which the massage mechanism described above is provided, and a pair of projecting sections 14 which project to the left and right-hand sides from the upper part of the backrest section 70.

The extending sections 14 have the shape described below. More specifically, the upper end of each projecting section 14 connects smoothly with the upper end of the backrest 1. Furthermore, the outer side faces of the projecting sections 14 in the left and right direction comprise a downward expanding portion 14a where the side faces are inclined in mutually separating directions toward the lower side, and an upward expanding portion 14b where the side faces are inclined in mutually approaching direction toward the lower side, from the downward expanding portion 14a. More specifically, the lower end of each projecting section 14 connects smoothly with an intermediate portion of the backrest 70. The amount of sideways projection of the projecting sections 14 becomes greater toward the lower side, in the range corresponding to the downward expanding portion 14a described above.

The side walls 15 project respectively forwards from the front surface of each of the projecting sections 14 described above. More specifically, the upper ends of the side walls 15 connect smoothly with the upper end of the backrest 1 (the respective projecting sections 14), as shown in FIG. 3 and FIG. 4. Furthermore, the amount by which the side walls 15 project forwards from the backrest 1 is greater in the lower part than in the upper part. The side walls 15 each have a lower surface which is substantially perpendicular to the backrest 1 (the projecting sections 14) and this lower surface connects with the backrest 1. Furthermore, as shown in FIG. 6, the side walls 15 respectively have outer surfaces 15a which extend forwards from the downward expanding portions 14a of each projecting section 14, so as to extend the downward expanding portions 14a of the projecting sections 14. Moreover, the side walls 15 respectively have inner side faces 15b which are surfaces facing in the opposite direction from the outer surfaces 15a, that are inclined in such a manner that the lower parts thereof are positioned to the outside of the upper parts thereof in the left and right direction.

The air bags 16 can be switched between an expanded state and a contracted state, in order to massage the side faces of a user who is leaning against the backrest 1. Furthermore, the air bags 16 are provided respectively on the inner side faces 15b of the side walls 15, in order to massage a region from the shoulders to the upper arms of the user. More specifically, the air bags 16 are provided through the whole range of the inner side faces 15b of the side walls 15, as shown in FIG. 1 and FIG. 2. In other words, the air bags 16 have a triangular shape in which the width dimension in the front and rear direction is greater in the lower part than in the upper part. Moreover, the air bags 16 are provided respectively along the inner side faces of the side walls 15, as shown in FIG. 6, and therefore the gap in the left/right direction between the air bags 16 becomes larger toward the lower side.

Referring to FIG. 1 to FIG. 4, the armrests 3 each respectively comprise a side plate 30 which is disposed to the side of the seat 2, a side cover 31 which covers the outer surface of the side plate 30, an armrest section 32 which covers the upper surface of the side plate 30, and an armrest cover 33 provided on the upper surface of the armrest section 32. The armrest cover 33 is attached on the armrest section 32 in such a manner that a gap is formed between the lower surface of the armrest cover 33 and the upper surface of the armrest section 32. More specifically, an installation member 34 (see FIG. 2) for attaching the armrest cover 33 on the armrest section 32 is provided between the lower surface of the front end portion of the armrest cover 33 and the upper surface of the armrest section 32. Moreover, an air bag (not illustrated) is provided on the lower surface of the armrest cover 33 (in other words, on the surface opposing the armrest section 32). By repeating expansion and contraction of the air bag, it is possible to massage the user's arm which is inserted between the upper surface of the armrest section 32 and the armrest cover 33.

The massager relating to the present embodiment changes the attitude of the pair of armrests 3 in conjunction with the reclining operation of the backrest 1, in such a manner that the rear part of each armrest 3 falls lower than the front part of each armrest 3 when the backrest 1 is reclined backwards.

More specifically, as shown in FIG. 3 and FIG. 4, the rear end part of the side plate 30 of each armrest 3 is coupled by an axle 35 to the backrest 1 (the backrest frame 10), and the front end part of the side plate 30 of each armrest 3 is coupled to the frame 5 via a link 36. The link 36 has a first end which is coupled rotatably with respect to the side plate 30 by an axle 37, and a second end which is coupled rotatably with respect to the frame 5 by an axle 38. In this way, the rear parts of the armrests 3 are coupled to the backrest 1 and the front parts of the armrests 3 are coupled to the frame 5 via the links 36, whereby the angle of the upper surface of each armrest 3 is tilted backwards and downwards by means of the armrest 3 rotating about the central axis 50 in synchronism with the reclining operation of the backrest 1. Moreover, since the front parts of the armrests 3 are coupled to the frame 5 via the links 36, then the front parts of the armrests 3 are allowed to rise until a prescribed upper position which is specified by the radius of rotation of the links 36 which rotate about the axles 38 (the distance between the axle 37 and the axle 38), and the rising of the front parts of the armrests 3 is restricted at a prescribed raising position. The length of the links 36 is shorter than the distance between the axles 35 and the central axis 50. Consequently, when the backrest 1 is in a fully reclined state, it is possible to keep the upper surface of the armrests 3 in a horizontal attitude, while shortening the distance between the backrest 1 and the rear parts of the armrests 3. In other words, in the present embodiment, the amount of change in the angle of the upper surfaces of the armrests 3 with respect to the frame 5 is smaller than the amount of change in the angle of the backrest 1 with respect to the frame 5. More specifically, in the state shown in FIG. 3 where the backrest 1 is upright, the angle al formed between the front surface of the backrest 1 and the upper surfaces of the armrests 3 is 115 degrees. On the other hand, in the state shown in FIG. 4 where the backrest 1 is reclined furthest, the angle a2 formed between the front surface of the backrest 1 and the upper surfaces of the armrests 3 is 160 degrees.

In the massager relating to the present embodiment, in contrast to a case where the armrests are fixed and only the backrest can be reclined, it is possible to keep the upper surfaces of the armrests 3 in a horizontal attitude while shortening the distance between the backrest 1 and the armrests 3, when the backrest 1 is in a reclined state. Therefore, the user is able to rest his or her arms on the armrests 3 in a relaxed state, even when the backrest 1 is reclined. Since the armrests 3 can be used with the backrest 1 in a reclined state in this way, then it is possible to carry out a massage of the user's arms (including the wrists and hands) by means of the air bags in the armrests 3.

The massager also comprises side plates 60 which are fixed to the frame 5 and which are provided along the inner surfaces (the surfaces on the seat 2 side) of the armrests 3, and air bags 61 which are provided on the inner surfaces (the surfaces on the seat 2 side) of these side plates 60. The side plates 60 are provided respectively between the seat 2 and the respective armrests 3, and are fixed to the frame 5 so as not to be displaced with respect to the seat 2, irrespective of the reclining operation of the backrest 1. By repeating expansion and contraction of the air bags 61, it is possible to massage the side of the user's hips and thighs, or alternatively, by expanding the air bags 61, it is possible to fix the sides of the user's hips and thighs with respect to the massager.

The massager relating to the present embodiment is designed so as to avoid contact between the projecting sections 14 of the backrest 1 and the armrests 3, during a reclining operation. More specifically, as shown in FIG. 3, a first distance D1 which links the central axis 50 of the reclining action with each of the projecting sections 14 is set to be longer than a longest distance D2 which links the central axis 50 to the armrests 3 that is positioned in the reclining range E1. Consequently, the projecting sections 14 each pass through a position that is further distant from the central axis 50 than the armrests 3, during a reclining operation, and therefore it is possible to avoid contact between the projecting sections 14 and the armrests 3.

Moreover, the massager relating to the present embodiment is designed so as to avoid contact between the side walls 15 of the backrest 1 and the armrests 3, during a reclining operation. More specifically, a second distance D3 which links the central axis 50 with each of the side walls 15, as shown in FIG. 3, is set to be longer then the longest distance D2 described above. Consequently, the side walls 15 each pass through a position that is further distant from the central axis 50 than the armrests 3, during a reclining operation, and therefore it is possible to avoid contact between the side walls 15 and the armrests 3.

Moreover, the massager relating to the present embodiment is designed so as to avoid contact between a user's arms which are resting on the armrests 3, and the projecting sections 14 and the side walls 15, during a reclining operation. In other words, the differences between the first distance D1 and the second distance D3, and the longest distance D2, are respectively set to be equal to or greater than the thickness of a user's arms which are resting on the armrests 3.

More specifically, in the present embodiment, the projecting sections 14 are provided only in the upper part of the backrest 1, and the side walls 15 are provided within the range of the projecting sections 14. Therefore, during a reclining operation, it is possible to avoid contact between the user's arms which are resting on the armrests 3, and the projecting sections 14 or the side walls 15. Moreover, the amount by which the projecting sections 14 project sideways from the side faces of the backrest section 70 is set to be smaller than the dimension between the respective outer surfaces of the armrests 3 which are provided on either side of the seat 2, and therefore it is possible to keep the packaged size of the massager small.

When the backrest 1 is reclined furthest backwards, the side walls 15 assume positions which are higher than the front surface of the backrest section 70 (the surface which receives the back of the user), but remain within a height range substantially the same as or lower than the height position of the distal end portion of the backrest section 70, and therefore in this respect also, it is possible to avoid increase in the size of the massager when packaged.

In this massager, it is possible to massage the sides of the user, from the shoulders to the upper arms, by repeating expansion and contraction of the air bags 16 which are disposed on the inner side of the side walls 15 of the backrest 1, while the user sitting on the seat 2 with his or her back leaning against the backrest 1. Furthermore, by fixing the user to the backrest 1 by expanding the air bags 16, it is possible to prevent the user from rising up from the backrest 1 when the massage mechanism provided inside the backrest 1 pushes the treatment element against the user from behind. Consequently, it is possible to apply a massage to the back of the user, more effectively.

Moreover, since the inner side faces of each side wall 15 are arranged in a downward broadening fashion in such a manner that they become further distanced from each other in the downward direction, as described above, and since the air bags 16 are provided along the inner side faces of each side wall 15, then it is possible reliably to press the inclined surfaces of the user's sides from the shoulders to the upper arms by means of the expanded air bags 16. In particular, since the air bags 16 have properties whereby the wide portion thereof swells greatly, then the lower part of each air bag 16 swells to a large size compared to the upper part, and pressure points on the upper side surfaces of the user's upper arms can be massaged effectively by the air bags 16. Moreover, if the seated height of the user varies slightly, then it is possible to prevent the occurrence of problems such as the application of too strong a pressing force, or too weak a pressing force.

As described above, according to the massager relating to the present embodiment, it is possible to massage a user's back by means of a massage mechanism inside the backrest section 70, while also massaging the user's shoulders or arms from the left and right sides by means of the air bags 16 provided respectively on the inner sides of the pair of side walls 15. Furthermore, in the massager relating to the present embodiment, it is possible to perform a massage by means of the massage mechanism, in a state where the user's body is prevented from lifting up from the backrest 1 by switching the air bags 16 to an expanded state. Therefore, it is possible to obtain a stronger massaging effect with this massager. Moreover, in the massager relating to the present embodiment, the backrest 1 has a backrest section 70 and a pair of projecting sections 14 which are formed integrally with the backrest section 70, and furthermore a pair of side walls 15 are provided on the front surfaces of the projecting sections 14, thus imparting unified form to the pair of side walls 15 and the backrest 1. In the massager relating to the present embodiment, since the projecting sections 14 for providing the pair of side walls 15 are provided separately from the backrest section 70, then it is possible to receive the whole of the user's back on the backrest section 70. Therefore, the user can receive a massage in a relaxed position.

According to the massager relating to the present embodiment, since the outer side faces in the left/right direction of the pair of side walls 15 are provided so as to extend the outer side faces of the pair of projecting sections 14, then an even more unified form can be imparted to the projecting sections 14 and the side walls 15.

According to the massager relating to the present embodiment, since the lower sides of the air bags 16 are positioned to the outside of the upper sides of the air bags, then it is possible to massage the portions from the user's shoulders to the user's upper arms, in an effective manner, by means of the air bags 16.

According to the massager relating to the present embodiment, since the projecting sections 14 pass through positions which are further distant from the central axis 50 than the armrests 3, during a reclining operation, then it is possible to avoid contact between the projecting sections 14 and the armrests 3 during a reclining operation of the backrest 1.

According to the massager relating to the present embodiment, by providing projecting sections 14 only in the upper part of the backrest section 70, it is possible to avoid contact between the projecting sections 14 and the armrests 3 during a reclining action of the backrest 1.

According to the massager relating to the present embodiment, since the side walls 15 pass through positions which are further distant from the central axis 50 than the armrests 3, during a reclining operation, then it is possible to avoid contact between the side walls 15 and the armrests 3 during a reclining operation of the backrest 1.

According to the massager relating to the present embodiment, since a gap corresponding to at least the thickness of a user's arms is formed between the projecting sections 14 and the armrests 3, then it is possible to suppress contact between the projecting sections 14 and the user's arms placed on the armrests 3 during a reclining operation.

According to the massager relating to the present embodiment, since the amount of forward projection of the side walls 15 becomes smaller toward the upper side, then it is possible to increase the sideways field of vision of the user seated against the backrest section 70. Moreover, according to the massager described above, it is possible to reduce the packaged size compared to a case where the amount of forward projection of the side walls 15 is uniform in the vertical direction.

According to the massager relating to the present embodiment, the amount of expansion of the lower parts of the air bags 16 is greater than the amount of expansion of the upper parts of the air bags 16, and therefore it is possible to perform a massage with substantially equal force regardless of the height on the user's back.

Below, a further embodiment is described with reference to FIG. 7 and FIG. 8. FIG. 7 is a perspective diagram showing a portion of a backrest relating to a further embodiment of the present invention. FIG. 8 is a plan diagram showing a rotational mechanism provided in the backrest in FIG. 7. The composition which is similar to the embodiment described above is labeled with the same reference numerals and description thereof is omitted here.

The backrest 1 relating to the present embodiment is the same as that of the embodiment described above in external appearance. However, the massager relating to the present embodiment comprises a rotational mechanism 71 for respectively connecting the side walls 15 to the backrest 1 rotatably in the left and right direction. The rotational mechanism 71 has a locking state which locks the side walls 15 at positions where the side walls 15 are extended forwards from the backrest 1, and an unlocking state which releases the locking of the side walls 15.

More specifically, the rotational mechanism 71 comprises protruding sections 15c which protrude backwards respectively from the rear surface of each side wall 15 and a pair of supporting sections 10a which respectively support the protruding sections 15c rotatably about an axis J1 extending in the vertical direction. The supporting sections 10a extends forwards from the left and right edge sections of the backrest frame 10 of the backrest 1. Furthermore, as shown in FIG. 8, the protruding sections 15c and the supporting sections 10a each have clearance holes formed in mutually overlapping positions in the vertical direction, in a state where the side walls 15 are rotated to a position of extending forwards from the backrest 1. By introducing locking shafts J2 into these clearance holes, the side walls 15 are locked. The locking shafts J2 can be inserted in the clearance holes and extracted from the clearance holes, in accordance with the operation of an external operating section by the user. In this way, the side walls 15 can be held in a forward facing attitude by the locking shafts J2, and therefore the rotation of the side walls 15 can be restricted when the air bags 16 are expanded.

In the present embodiment, since the side walls 15 can be folded back in the left/right direction, then if massaging, or securing of the user's body, by the air bags 16 is not required, it is possible to reduce the sense of constriction applied to the user leaning against the backrest 1, by the side walls 15. More specifically, by folding the side walls 15 outwards in the left and right direction, it is possible to open up the user's sideways field of vision, and therefore the sense of constriction applied to the user can be lightened. Moreover, since the amount by which the side walls 15 project forwards from the backrest 1 can be reduced virtually to zero by folding back the side walls 15, then it is possible to keep a small packaged size.

In the embodiment in FIG. 8, it is possible to rotate the side walls 15 to both the left and right-hand sides when the locking by the locking shafts J2 is released, but the sense of constriction on the user can be lightened provided that the side walls 15 can be rotated outwards in at least the left or right direction. More specifically, for example, it is possible to provide stoppers for restricting inward rotation of the protruding sections 15c, between the protruding sections 15c and the supporting sections 10a.

Below, yet a further modification example is described with reference to FIG. 9 and FIG. 10. FIG. 9 is a perspective diagram showing a portion of a backrest relating to a further embodiment of the present invention. FIG. 10 is a plan diagram showing a sliding mechanism provided in the backrest in FIG. 9. The composition which is similar to the respective embodiments described above is labeled with the same reference numerals and description thereof is omitted here.

As shown in FIG. 10, the massager relating to the present embodiment comprises a sliding mechanism 72 for connecting the side walls 15 slidably in the up/down direction with respect to the projecting sections 14.

More specifically, the sliding mechanism 72 comprises a pair of rails 10b provided on the front surface of the backrest frame 10 of the backrest 1, a pair of sliders 15e which are respectively attached slidably in the up/down direction with respect to the rails 10b, and a connecting section 15d which connects the sliders 15e with the side walls 15. The width dimension of the connecting section 15d in the left/right direction is smaller than the width dimension of the sliders 15e in the left/right direction. The rails 10b each comprise a slide groove 10c into which the slider 15e can be inserted, and a slit 10d for passing the connecting section 15d in a state where the slider 15e has been inserted into the slide groove 10c. The width dimension of the slit 10d in the left/right direction is smaller than the width dimension of the slide groove 10c in the left/right direction. Therefore, by inserting the sliders 15e into the slide grooves 10c while passing the connecting section 15d into the slit 10d, the side walls 15 are allowed to perform a sliding action in the up/down direction, while restricting movement thereof in the forward/backward direction with respect to the backrest 1.

According to the present embodiment, since the upper and lower positions of the side walls 15 with respect to the backrest 1 can be changed, then it is possible to perform more effective massaging, by adjusting the side walls 15 to the user's stature.

Below, yet a further embodiment is described with reference to FIG. 11. FIG. 11 is a perspective diagram showing a portion of a backrest relating to yet a further embodiment of the present invention.

The backrest 1 shown in FIG. 11 comprises a pair of protruding sections 17 which protrude from the front surface of the backrest section 70, and air bags 18 which are provided on these protruding sections 17. The protruding sections 17 have front side faces which are inclined so as to descend toward the backrest section 70 in the inward left and right direction, and air bags 18 are provided respectively on these front side faces. By repeating expansion and contraction of the air bags 18, it is possible to perform massaging of the sides of the user's hips and the user's sides, as well as being able to secure the user's hips in position with respect to the backrest section 70 by expanding the air bags 18.

The concrete embodiments described above principally include an invention having the following composition.

The massager relating to the present embodiment comprises: a backrest including, in an integrated fashion, a backrest section in which a massage mechanism for massaging a user's back is provided, and a pair of projecting sections which project to left and right-hand sides from at least an upper part of the backrest section; a pair of side walls which respectively project forwards from front surfaces of the pair of projecting sections; and a pair of massage members which are provided respectively on inner side faces of the pair of side walls and which can be switched between an expanded state and a contracted state in order to massage the sides of the user leaning against the backrest section.

According to the massager relating to the present embodiment, it is possible to massage a user's back by means of a massage mechanism provided in the backrest section, while also massaging the user's shoulders or arms from the left and right sides by means of the massage members provided respectively on the inner sides of the pair of side walls. Moreover, in the massager relating to the present embodiment, massaging by the massage mechanism can be performed in a state where the user's body is restricted from lifting up from the backrest, by switching the massage members to an expanded state, and therefore it is possible to achieve an even stronger massaging effect. Moreover, in the massager relating to the present embodiment, the backrest has a backrest section and a pair of projecting sections which are formed integrally with the backrest section, and furthermore a pair of side walls are provided on the front surfaces of the projecting sections, thus imparting a unified form to the pair of side walls and the backrest. In the massager relating to the present embodiment, since the projecting sections for providing the pair of side walls are provided separately from the backrest section, then it is possible to receive the whole of the user's back on the backrest section. Therefore, the user can receive a massage in a relaxed position.

In the massage described above, desirably, outer side faces of the pair of side walls in a left and right direction respectively extend forwards from outer side faces of the pair of projecting sections so as to extend the outer side faces of the projecting sections.

According to the massager, since the outer side faces of the pair of side walls are provided so as to extend the outer side faces of the pair of projecting sections, then the projecting sections and the side walls create an even more unified form.

In the massager described above, desirably, each of the inner side faces of the pair of side walls in a left and right direction is inclined in such a manner that a lower part thereof is positioned to the outside of an upper part thereof in the left and right direction.

According to the massager described above, since the inner side faces of the side walls are inclined in such a manner that the lower parts thereof are positioned to the outside of the upper parts thereof, then the lower sides of the pair of massage members provided along the inner side faces of the side walls are positioned to the outside of the upper sides thereof. Consequently, according to the massager described above, it is possible to perform effective massaging of a portion from the user's shoulders to upper arms, by means of the massage members.

The massager described above, desirably, further comprises a pair of armrests which extend forwards from positions on the left and right sides of the backrest; wherein the backrest is reclinable in a reclining range between an upright attitude and a reclined attitude; and a first distance between a central axis of reclining and the pair of projecting sections is longer than a longest distance linking the pair of armrests positioned in the reclining range to the central axis.

According to the massager described above, since the projecting sections pass through positions which are further distant from the central axis than the armrests during a reclining operation, it is possible to avoid contact between the projecting sections and the armrests when the backrest is reclined.

The “first distance” is a line segment which links the central axis with the portion of the projecting sections closest to the central axis in a plane perpendicular to the central axis of reclining. Furthermore, the “longest distance” is a line segment linking the central axis with the portion of the armrests situated furthest from the central axis in a plane perpendicular to the central axis, when the armrests are positioned in the reclining range of the backrest.

In the massager described above, desirably, the pair of projecting sections are respectively provided only in the upper part of the backrest section.

According to the massager described above, it is possible to avoid contact between the projecting sections and the armrests when the backrest is reclined, by providing the projecting sections only in the upper part of the backrest section.

In the massager described above, desirably, a second distance between the central axis of the pair of side walls is longer than the longest distance.

According to the massager described above, since the side walls pass through positions which are further distant from the central axis than the armrests during a reclining operation, it is possible to avoid contact between the side walls and the armrests when the backrest is reclined.

The “second distance” is a line segment which links the central axis to the portion of the side walls closest to the central axis in a plane perpendicular to the central axis.

In the massager described above, desirably, a difference between the first distance and the longest distance is set to be equal to or greater than a thickness of the user's arms which are resting respectively on the pair of armrests.

According to the massager described above, since a gap corresponding to at least the thickness of a user's arms is formed between the projecting sections and the armrests, then it is possible to suppress contact between the projecting sections and the user's arms resting on the armrests during a reclining operation.

Desirably, the massager described above further comprises a rotational mechanism for respectively connecting the pair of side walls to the backrest in a rotatable fashion in the left and right direction.

According to the massager described above, since the side walls can be rotated to the left and right, then it is possible to fold back the side walls without the side walls becoming a nuisance. Consequently, the packaged size of the massager can be reduced, for example.

In the massager described above, desirably, the rotational mechanism has a locking state which locks the pair of side walls at positions where the side walls are extended forwards from the backrest, and an unlocking state which releases locking of the side walls.

According to the massager described above, since the rotational mechanism can be switched between an unlocking state where the side walls can be rotated, and a locking state where the side walls are locked, then massaging of a user can be carried out with the side walls in a locking state, in addition to which the side walls can be folded back when a massage is not being performed, so as to make the massager compact.

Desirably, the massager described above further comprises a sliding mechanism for respectively connecting the pair of side walls to the backrest in a slidable fashion in an upward and downward direction.

According to the massager described above, it is possible to slide the side walls up and down in accordance with the user's stature, and therefore more effective massaging can be performed.

In the massager described above, desirably, an amount of projection of each of the pair of side walls towards the front from the backrest is greater in a lower part thereof than in an upper part thereof.

According to the massager described above, since the amount of forward projection of the side walls becomes smaller toward the upper side, then it is possible to increase the sideways field of vision of the user seated against the backrest section. Moreover, according to the massager described above, it is possible to reduce the packaged size compared to a case where the amount of forward projection of the side walls is uniform in the vertical direction.

In the massager described above, desirably, a width dimension of each of the pair of massage members in a front and rear direction is greater in a lower part thereof than in an upper part thereof.

According to the massager described above, the amount of expansion of the lower parts of the massage members is greater than the amount of expansion of the upper parts of the massage members, and therefore it is possible to perform a massage with substantially equal force regardless of the height on the user's back.

### INDUSTRIAL APPLICABILITY

According to the present invention, it is possible to provide a massager in which a backrest and side walls holding massage members have a unified form.

### EXPLANATION OF REFERENCE NUMERALS

D1 first distance

D2 longest distance

D3 second distance

E1 reclining range

1 backrest

10 backrest frame

14 projecting section

15 side wall

15a outer side face (of side wall)

15b inner side face (of side wall)

16 air bag (example of massage member)

50 central axis

70 backrest section

71 rotational mechanism

72 sliding mechanism

1. A massager, comprising:
a backrest including, in an integrated fashion, a backrest section in which a massage mechanism for massaging a user's back is provided, and a pair of projecting sections which project to left and right-hand sides from at least an upper part of the backrest section;
a pair of side walls which respectively project forwards from front surfaces of the pair of projecting sections; and
a pair of massage members which are provided respectively on inner side faces of the pair of side walls and which can be switched between an expanded state and a contracted state in order to massage the sides of the user leaning against the backrest section.

2. The massager according to claim 1, wherein outer side faces of the pair of side walls in a left and right direction respectively extend forwards from outer side faces of the pair of projecting sections so as to extend the outer side faces of the projecting sections.

3. The massager according to claim 1, wherein each of the inner side faces of the pair of side walls in a left and right direction is inclined in such a manner that a lower part thereof is positioned to the outside of an upper part thereof in the left and right direction.

4. The massager according to claim 1,
further comprising a pair of armrests which extend forwards from positions on the left and right sides of the backrest,
wherein the backrest is reclinable in a reclining range between an upright attitude and a reclined attitude, and
a first distance between a central axis of reclining and the pair of projecting sections is longer than a longest distance linking the pair of armrests positioned in the reclining range to the central axis.

5. The massager according to claim 4, wherein the pair of projecting sections are respectively provided only in the upper part of the backrest section.

6. The massager according to claim 4, wherein a second distance between the central axis and the pair of side walls is longer than the longest distance.

7. The massager according to claim 4, wherein a difference between the first distance and the longest distance is set to be equal to or greater than a thickness of the user's arms which are resting respectively on the pair of armrests.

8. The massager according to claim 1, further comprising a rotational mechanism for respectively connecting the pair of side walls to the backrest in a rotatable fashion in the left and right direction.

9. The massager according to claim 8, wherein the rotational mechanism has a locking state which locks the pair of side walls at positions where the side walls are extended forwards from the backrest, and an unlocking state which releases locking of the side walls.

10. The massager according to claim 1, further comprising a sliding mechanism for respectively connecting the pair of side walls to the backrest in a slidable fashion in an upward and downward direction.

11. The massager according to claim 1, wherein an amount of projection of each of the pair of side walls towards the front from the backrest is greater in a lower part thereof than in an upper part thereof.

12. The massager according to claim 11, wherein a width dimension of each of the pair of massage members in a front and rear direction is greater in a lower part thereof than in an upper part thereof.
